(19) United States
(12) Patent Application Publication
(10) Pub. No.: US 2021/0160031 A1
(43) Pub. Date: May 27, 2021

(54) USER TERMINAL AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP)

(73) Assignee: NTT DOCOMO, INC., Tokyo (CN)

(21) Appl. No.: 16/612,588

(22) PCT Filed: May 12, 2017
(86) PCT No.: PCT/JP2017/018121

§ 371 Date: Nov. 11, 2019

(51) Int. Cl. H04L 5/00; H04L 27/32; H04L 27/26; H04W 72/04

(52) U.S. Cl. CPC H04L 5/0053; H04L 5/0044; H04W 72/0413; H04L 27/2636; H04L 27/32

(57) ABSTRACT

Preventing a decline in coverage and transmitting UCI, in future radio communication systems in which a DFT-spread OFDM waveform and a CP-OFDM waveform are supported. According to the present invention, a user terminal has a transmission section that transmits an uplink (UL) data channel, and a control section that, when a multi-carrier waveform is applied to the UL data channel, controls the transmission of UCI by using the UL data channel or by using a UL control channel that is time-division-multiplexed with the UL data channel.

### TECHNICAL FIELD

The present invention relates to a user terminal and a radio communication method in next-generation mobile communication systems.

### BACKGROUND ART

In the UMTS (Universal Mobile Telecommunications System) network, the specifications of long-term evolution (LTE) have been drafted for the purpose of further increasing high speed data rates, providing lower delays and so on (see non-patent literature 1). In addition, successor systems of LTE are also under study for the purpose of achieving further broadbandization and increased speed beyond LTE (referred to as, for example, “LTE-A (LTE-Advanced),” “FRA (Future Radio Access),” “4G,” “5G,” “5G+(plus),” “NR (New RAT),” “LTE Rel. 14,” “LTE Rel. 15 (or later versions),” and so on).

The uplink (UL) in existing LTE systems (for example, LTE Rel. 8 to 13) supports a DFT-spread OFDM (DFT-S-OFDM (Discrete Fourier Transform-Spread-Orthogonal Frequency Division Multiplexing)) waveform. The DFT-spread OFDM waveform is a single-carrier waveform, so that it is possible to prevent the peak-to-average power ratio (PAPR)) from increasing.

Also, in existing LTE systems (for example, LTE Rel. 8 to 13), a user terminal transmits uplink control information (UCI) by using a UL data channel (for example, PUSCH (Physical Uplink Control CHannel)) and/or a UL control channel (for example, PUCCH (Physical Uplink Control CHannel)).

To be more specific, when simultaneous transmission of PUSCH and PUCCH is configured, if there is a PUSCH to be transmitted, the user terminal transmits some UCI (for example, delivery acknowledgment information (also referred to as “HARQ-ACK (Hybrid Automatic Repeat reQuest-ACKnowledgment),” “ACK” or “NACK (Negative ACK),” “A/N” and the like) for a DL data channel (for example, PDSCH (Physical Downlink Shared CHannel) by using a PUCCH, and transmits other UCI (for example, channel state information (CSI)) by using the PUSCH.

### CITATION LIST

### Non-Patent Literature

Non-Patent Literature 1: 3GPP TS36.300 V8.12.0 “Evolved Universal Terrestrial Radio Access (E-UTRA) and Evolved Universal Terrestrial Radio Access Network (E-UTRAN); Overall Description; Stage 2 (Release 8),” April, 2010

### SUMMARY OF INVENTION

### Technical Problem

The PUCCH of existing LTE systems (for example, LTE Rel. 8 to 13) is subjected frequency hopping in a subframe (which is a 1-ms transmission time interval (TTI)) and allocated to fields at both ends of the system ban. Therefore, the above simultaneous transmission of PUSCH and PUCCH takes place in discrete frequency resource fields (for example, in fields at both ends of the system band and in frequency resource fields allocated to a user terminal apart from the fields at both ends) (that is, PUSCH and PUCCH are frequency-division-multiplexed).

Now, envisaging the UL of future radio communication systems (for example, LTE 5G, NR, etc.), research is underway to support a cyclic prefix-OFDM (CP-OFDM (Cyclic Prefix-Orthogonal Frequency Division Multiplexing)) waveform, which is a multi-carrier waveform, in addition to the DFT-spread OFDM waveform, which is a single-carrier waveform.

When a PUSCH and a PUCCH are simultaneously transmitted, as in existing LTE systems, in the UL of such future radio communication systems, even if the CP-OFDM waveform is used for the PUSCH, there is still a fear that the PUSCH and the PUCCH are transmitted in discrete frequency resource fields, and, as a result of this, the coverage cannot be maintained.

The present invention has been made in view of the above, and it is therefore an object of the present invention to provide a user terminal and a radio communication method that are capable of preventing a decline in coverage and transmitting UCI, in future radio communication systems in which the DFT-spread OFDM waveform and the CP-OFDM waveform are supported.

### Solution to Problem

According to one aspect of the present invention, a user terminal has a transmission section that transmits an uplink (UL) data channel, and a control section that, when a multi-carrier waveform is applied to the UL data channel, controls the transmission of UCI by using the UL data channel or by using a UL control channel that is time-division-multiplexed with the UL data channel.

### Advantageous Effects of Invention

According to the present invention, it is possible to prevent a decline in coverage and transmitting UCI, in future radio communication systems in which a DFT-spread OFDM waveform and a CP-OFDM waveform are supported.

### BRIEF DESCRIPTION OF DRAWINGS

FIGS. 1A and 1B are diagrams, each showing an example of a PUSCH transmitter in future radio communication systems;

FIG. 2 is a diagram to show an example of simultaneous PUSCH and PUCCH transmission;

FIG. 3 is a diagram to show a first example of piggyback according to a first example of the present invention;

FIG. 4 is a diagram to show a second example of piggyback according to the first example;

FIGS. 5A and 5B are diagrams, each showing a first example of TDM according to a second example of the present invention;

FIGS. 6A and 6B are diagrams, each showing a second example of TDM according to the second example;

FIG. 7 is a diagram to show an exemplary schematic structure of a radio communication system according to the present embodiment;

FIG. 8 is a diagram to show an exemplary overall structure of a radio base station according to the present embodiment;

FIG. 9 is a diagram to show an exemplary functional structure of a radio base station according to the present embodiment;

FIG. 10 is a diagram to show an exemplary overall structure of a user terminal according to the present embodiment;

FIG. 11 is a diagram to show an exemplary functional structure of a user terminal according to the present embodiment; and

FIG. 12 is a diagram to show an exemplary hardware structure of a radio base station and a user terminal according to the present embodiment.

### DESCRIPTION OF EMBODIMENTS

Envisaging the UL of future radio communication systems (for example, LTE 5G, NR, etc.), research is underway to support a cyclic-prefix OFDM (CP-OFDM) waveform, which is a multi-carrier waveform (and which is a UL signal, to which DFT is not applied (or “without DFT spreading”)), in addition to a DFT-spread OFDM waveform, which is a single-carrier waveform (and which is a UL signal, to which DFT spreading (also referred to as “DFT precoding” and the like) is applied (or “with DFT spreading”)).

Whether or not DFT spreading is applied to (which one of the DFT-spread OFDM waveform and the CP-OFDM waveform is used for) the PUSCH might be configured in or indicated to a user terminal by using the network (for example, a radio base station).

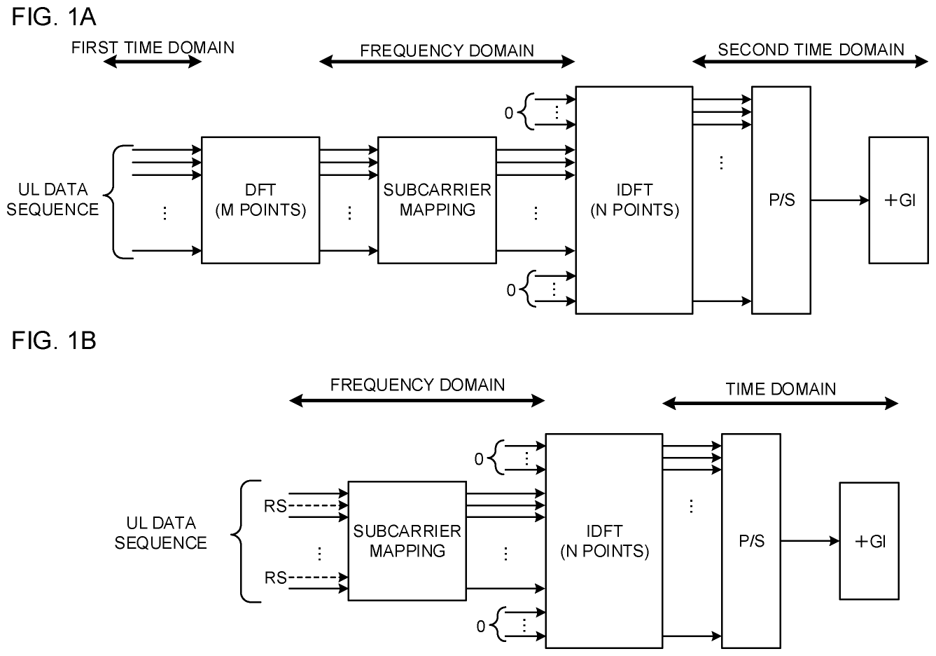

FIG. 1 are diagrams, each showing an example of a PUSCH transmitter in future radio communication systems. FIG. 1A shows an example of a transmitter using the DFT-spread OFDM waveform. As shown in FIG. 1A, UL data sequences after coding and modulation are subjected to a discrete Fourier transform (DFT) (or a fast Fourier transform (FFT)) of M points, converted from a first time domain to the frequency domain. Outputs of the DFT are mapped to M subcarriers, subjected to an inverse discrete Fourier transform (IDFT) (or an inverse fast Fourier transform (IFFT)) of N points, and converted from the frequency domain to a second time domain.

Here, N>M holds, and information that is input to the IDFT (or the IFFT) but not used is configured to zero. By this means, IDFT outputs give signals with little instantaneous power fluctuation, and their bandwidth depends on M. IDFT outputs are subjected to a parallel/serial (P/S) conversion, and then guard intervals (GIs) (also referred to as “cyclic prefixes (CPs)” and the like) are attached. In this way, signals that have characteristics of single-carrier communication are generated by DFT-spread OFDM transmitter, and transmitted in 1 symbol.

FIG. 1B shows an example of a transmitter using the CP-OFDM waveform. As shown in FIG. 1B, UL data sequences and/or reference signals (RSs), which have been encoded and modulated, are mapped to a number of subcarriers equal to the transmission bandwidth, and subjected to an IDFT (or an IFFT). Information that is input to the IDFT but not used is configured to zero. IDFT outputs are subject to a P/S conversion, and GIs are inserted. In this way, since the CP-OFDM transmitter uses multiple carriers, it is possible to frequency-division-multiplex RSs and UL data sequences.

Also, in future radio communication systems, the PUSCH is transmitted in a certain number of symbols. The number of symbols used to transmit the PUSCH is not fixed, and may be changed (variable) based on the number of symbols in one or more slots.

Furthermore, in future radio communication systems, the PUCCH is transmitted using a certain number of symbols in a slot. The number of symbols used to transmit the PUCCH is not fixed, and may be changed (variable). For example, research is underway to support a PUCCH that is structured to be shorter in duration (for example, 1 or 2 symbols (hereinafter also referred to as a “short PUCCH”) than PUCCH formats 1 to 5 of existing LTE systems (for example, LTE Rel. 13 and earlier versions) and/or, a PUCCH that is structured to have a longer duration than the above short duration (hereinafter also referred to as a “long PUCCH”).

To be more specific, when simultaneous transmission of PUSCH and PUCCH is configured in existing LTE systems (for example, LTE Rel. 13 and earlier versions), if there is a PUSCH to transmit, a user terminal transmits some UCI (for example, HARQ-ACK) by using a PUCCH, and transmits other UCI (for example, CSI) by using the PUSCH.

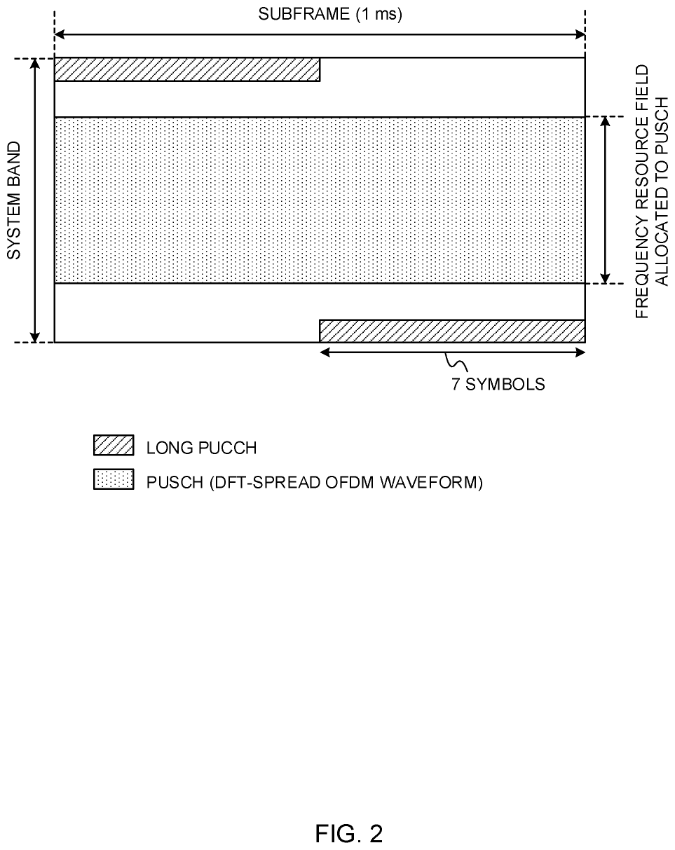

FIG. 2 is a diagram to show an example of simultaneous PUSCH and PUCCH transmission. As shown in FIG. 2, the PUCCH (PUCCH format 1 to 5) of existing LTE systems (for example, LTE Rel. 13 and earlier versions) hops from frequency to frequency for every certain number of symbols in a subframe (7 symbols in the event normal cyclic prefix is used) and is allocated to fields at both ends of the system band (also referred to as “CC,” etc.).

Also, as shown in FIG. 2, the PUSCH is allocated to a frequency resource field (for example, a certain number of contiguous resource blocks (also referred to as “RBs,” “physical resource blocks (PRBs),” etc.) that is allocated to a user terminal by downlink control information (DCI).

However, as described above, it is predictable that the CP-OFDM waveform will be used for the PUSCH in future radio communication systems (for example, LTE 5G, NR, etc.). Therefore, as shown in FIG. 2, when a PUSCH and a PUCCH are transmitted simultaneously in non-contiguous frequency fields (frequency domain), it may not be possible to maintain the coverage.

So, assuming a case where the CP-OFDM waveform is applied to a PUSCH, the present inventors have come up with the idea of piggybacking UCI on the PUSCH (the first example), or transmitting UCI by using a short PUCCH that is time-division-multiplexed (TDM) with the PUSCH (the second example), so that UCI can be transmitted while preventing a decline in coverage.

Now, the present embodiment will be described below. Hereinafter, the CP-OFDM waveform will be shown as an example of a multi-carrier waveform and the DFT-spread OFDM waveform will be shown as an example of a single-carrier waveform, but the present embodiment can be appropriately applied to other multi-carrier waveforms than the CP-OFDM waveform, and to other single-carrier waveforms than the DFT-spread OFDM waveform.

Note that the DFT-spread OFDM waveform can be regarded as a DFT spreading (also referred as to “DFT precoding” and the like) is applied (the phrase “with DFT spreading” may be used hereinafter), and the CP-OFDM waveform can be regarded as a DFT spreading is not applied (the phrase “without DFT spreading” may be used hereinafter).

Also, in the present embodiment, UCI may include at least one of a scheduling request (SR), an HARQ-ACK, CSI, beam index information (BI (Beam Index)), and a buffer status report (B S R).

### First Example

According to a first example of the present invention, when the CP-OFDM waveform is applied to a PUSCH, UCI is transmitted using this PUSCH (piggybacked on the PUSCH). Here, the UCI is mapped to frequency resources that are spread in the frequency resource field allocated to this PUSCH (frequency-domain interleaving is applied in the frequency direction (“with freq-domain interleaving”)).

With the first example, when a PUSCH of the CP-OFDM waveform is transmitted in one or more symbols, UCI may be mapped to frequency resources (for example, one or more resource elements (REs), one or more subcarriers, one or more PRBs, etc.) that are spread in the frequency resource field allocated to this PUSCH (the first example of piggyback).

Alternatively, in part of the symbols allocated to the PUSCH of the CP-OFDM waveform, the DFT-spread OFDM waveform may be applied to this PUSCH. In these partial symbols, UCI may be mapped to frequency resources that are spread in the frequency resource field allocated to this PUSCH (the second example of piggyback).

<First Example of Piggyback>

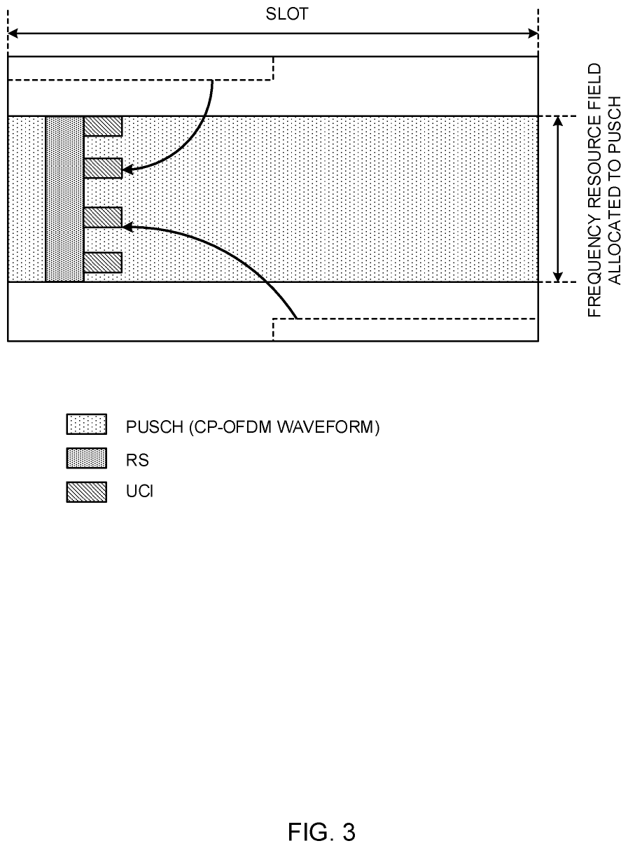

FIG. 3 is a diagram to show a first example of piggyback according to a first example of the present invention. FIG. 3 shows an example, in which, when a user terminal transmits a PUSCH of the CP-OFDM waveform in a UCI-transmitting slot, the user terminal transmits UCI using this PUSCH of the CP-OFDM waveform.

For example, referring to FIG. 3, a PUSCH of the CP-OFDM waveform is transmitted in a certain number of symbols (for example, 1 symbol), and the user terminal maps UCI to frequency resources (here, a plurality of REs) that are spread in the frequency resource field allocated to this PUSCH (this mapping is also referred to as “UCI on PUSCH,” “piggyback,” etc.).

As shown in FIG. 3, the UCI may be mapped to a certain number of symbols before and/or after (before/after) the symbol where the reference signal for demodulating the PUSCH (also referred to as “RS” or “DMRS (DeModulation Reference Signal)” and the like) is allocated (for example, in FIG. 3, the UCI is mapped to 1 symbol immediately after the symbol where the RS is allocated). Also, the UCI may be mapped to a certain number of symbols adjacent to and/or not adjacent (adjacent/not adjacent) to the symbol where the RS is allocated.

Note that the locations and the number of symbols to which the RS is allocated are not limited to those shown in FIG. 3. Also, as shown in FIG. 3, when the OFDM waveform is applied to a PUSCH, in symbols where the RS is allocated, the RS and UL data may be frequency-division-multiplexed (FDM), or the RS alone may be mapped.

For example, in FIG. 3, the user terminal may apply rate matching and/or puncturing (rate matching/puncturing) to the PUSCH (also referred to as “UL data,” etc.), multiplex the UCI and UL data in the pre-IDFT frequency domain (see FIG. 1B), and map the UCI to a plurality of discrete REs.

Here, when the CP-OFDM waveform is applied, virtual frequency interleaving, which spreads certain data in the frequency direction as in the DFT-spread OFDM waveform, is not used. Therefore, the user terminal may map the UCI to discrete subcarriers upon entry to the subcarrier mapping in FIG. 1B.

Note that the bandwidth of the PUSCH can vary dynamically depending on the amount of frequency resources scheduled. In this case, the locations and/or intervals of REs where the UCI is mapped may not vary regardless of the scheduled bandwidth of the PUSCH. For example, UCI may be mapped to fixed RE locations in RBs where the PUSCH is scheduled. In this case, the location of UCI can be aligned between different UEs scheduled in different cells, so that inter-cell interference be reduced. UCI's RE location may be punctured based on commands given in higher layer signaling or physical layer signaling. In this case, it is possible to reduce interference against the UCI of users that transmit UCI-containing PUSCHs in nearby cells.

Alternatively, the locations and/or intervals of REs where UCI is mapped may vary depending on the bandwidth in which the PUSCH is scheduled. For example, UCI may be mapped to more sparsely when the bandwidth is wider, or mapped more densely when the bandwidth is narrower. Also, when the bandwidth is narrower than a certain threshold, UCI may be mapped over multiple symbols. At least one of the locations of REs, the intervals and the number of symbols of REs for mapping UCI may be determined based on at least one of the type of the UCI, the payload of the UCI (the number of bits), parameters provided by higher layer signaling, the bandwidth of the PUSCH, the number of MIMO (Multiple-Input and Multiple-Output) layers of PUSCH data, the modulation and coding scheme (MCS) index of PUSCH data, and so forth. In this case, even when the PUSCH bandwidth changes, an appropriate amount of resources to achieve the required coding rate of UCI can be reserved, so that the coding rate of UCI can be lowered, and the error rate can be reduced.

Whether the locations and/or intervals of REs for mapping UCI are fixed or are variable regardless of the bandwidth in which the PUSCH is scheduled may be configured by higher layer signaling. In this case, the network can select different configurations depending on services, operability and so forth and indicate them to terminals.

In the first example of piggyback, even when UCI rides piggyback on a PUSCH of the CP-OFDM waveform, the UCI is mapped (interleaved) to distributed frequency resources within the frequency resource field allocated to the PUSCH, so that a frequency diversity effect can be obtained for UCI.

<Second Example of Piggyback>

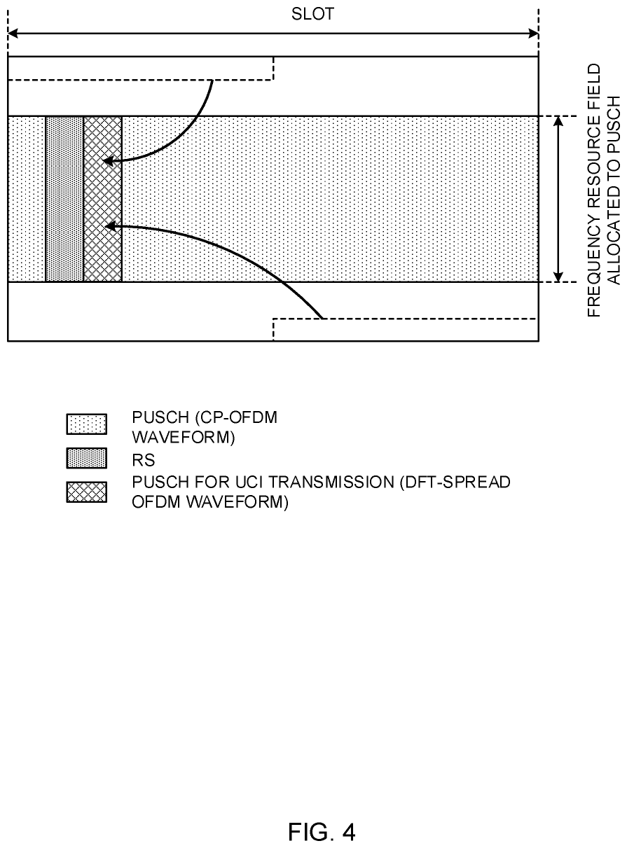

FIG. 4 is a diagram to show a second example of piggyback according to the first example. FIG. 4 shows an example in which, when a user terminal transmits a PUSCH of the CP-OFDM waveform in a UCI-transmitting slot, the user terminal applies the DFT-spread OFDM waveform to the PUSCH in part of the symbols in the slot, and transmits UCI in these symbols.

For example, in FIG. 4, the user terminal uses the DFT-spread OFDM waveform in part of the symbols (for example, 1 symbol) in the slot in which the PUSCH of the CP-OFDM waveform is allocated. The user terminal transmits UCI using the PUSCH of the DFT-spread OFDM waveform in these symbols. In the other symbols in the slot, the user terminal uses the CP-OFDM waveform.

As shown in FIG. 4, part of the symbols where the PUSCH of the DFT-spread OFDM waveform is allocated may be a certain number of symbols before and after the symbol where the RS is allocated (for example, in FIG. 4, the symbol immediately after the symbol where the RS is allocated). Also, these partial symbols may be a certain number of symbols adjacent/not adjacent to the symbol where the RS is allocated.

For example, referring to FIG. 4, the user terminal may apply rate matching/puncturing to the PUSCH (also referred to as “UL data” and the like), multiplex the UCI with UL data in the first time domain before the DFT (see FIG. 1A), and input this to the DFT. In DFT-spreading OFDM, UCI is mapped to spread frequency resources spread within the frequency resource field allocated to the PUSCH, by virtual frequency interleaving.

According to the second example of piggyback, the DFT-spread OFDM waveform is applied to some symbols in the slot in which the PUSCH of the CP-OFDM waveform is transmitted, and UCI rides piggyback on the PUSCH of the DFT-spread OFDM waveform, so that, by virtue of virtual frequency interleaving, the UCI is allocated to spread frequency resources. Therefore, a frequency diversity effect for the UCI can be gained.

Note that, with the second example of piggyback, the user terminal may control the transmission power of a PUSCH of the DFT-spread OFDM waveform in some symbols based on the transmission power of a PUSCH of the CP-OFDM waveform in other symbols (for example, the transmission power of the PUSCH of the DFT-spread OFDM waveform may be adjusted to the transmission power of the PUSCH of the CP-OFDM waveform). For example, the maximum transmission power upon transmission power calculation (the maximum power P_{CMAX} per user terminal, or the maximum power P_{CMAX,c} per component carrier (cell) transmitted by the user terminal) is calculated on assumption that a PUSCH of the CP-OFDM waveform is transmitted, and its value is also applied to PUSCH symbols where the DFT-spread OFDM waveform is applied.

Also, in the second example of piggyback, the user terminal may assume that the number of PRBs to be scheduled is the value given by the multiplication of the power of 2, the power of 3 and the power of 5. In general, it is known that, when the number of PRBs to which DFT spreading is applied is the above value, the calculation processing in the user terminal can be reduced. Even when a PUSCH of the CP-OFDM waveform is scheduled, if DFT-spreading is applied to part of the symbols, the processing load on the user terminal can be reduced by limiting the number of PRBs to the above value.

Also, in the second example of piggyback, the user terminal may assume that the number of symbols to be scheduled is at least 2 or greater. In general, it is difficult to multiplex RS and UCI while keeping the PAPR low in symbols where DFT-spreading is applied. Even when a PUSCH of the CP-OFDM waveform is scheduled, if DFT-spreading is applied to part of the symbols, the RS can be multiplexed over other symbols where DFT spreading is not applied, by limiting the number of symbols to 2 or more, so that the PAPR can be kept low.

Also, with the second example of piggyback, the number of symbols where UCI is multiplexed and where DFT-spreading is applied is not limited to 1, 2 or more symbols may be used. As in the first example of piggyback, by changing UCI resources depending on the payload of UCI and so on, the coding rate of UCI can be kept low regardless of the bandwidth of the PUSCH, so that the error rate of UCI can be reduced.

As described above, according to the first example, when the CP-OFDM waveform is used for a PUSCH, the PUSCH and a long PUCCH are not transmitted simultaneously, and, instead, UCI rides piggyback, and is mapped to spread frequency resources within the frequency resource field allocated to the PUSCH. By this means, the user terminal can transmit UCI while preventing the decline in coverage caused by the above-mentioned simultaneous transmission.

### Second Example

According to a second example of the present invention, when the CP-OFDM waveform is applied to a PUSCH, UCI is transmitted by using a short PUCCH that is time-division multiplexed (TDM) with this PUSCH. To be more specific, with the second example, UCI may be redirected from a long PUCCH to the short PUCCH that is time-division multiplexed (TDM) with the PUSCH.

Also, the short PUCCH that is time-division multiplexed (TDM) with the PUSCH may be mapped to a certain number of symbols before and/or after the PUSCH of the CP-OFDM waveform (the first example of TDM). Also, part of the symbols allocated to the PUSCH may be punctured. In this case, the PUSCH data may be punctured by the proportion of the punctured symbols, or rate matching to match the proportion of the symbols may be applied. the short PUCCH that is time-division-multiplexed (TDM) with the PUSCH may be mapped to the punctured symbols (the second example of TDM).

Also, in the first and second examples of TDM, at least a part of the frequency resources (for example, one or more REs, one or more subcarriers, one or more PRBs, and so forth) in the frequency resource field allocated to this PUSCH may be allocated to a short PUCCH that is time-division-multiplexed (TDM) with the PUSCH.

<First Example of TDM>

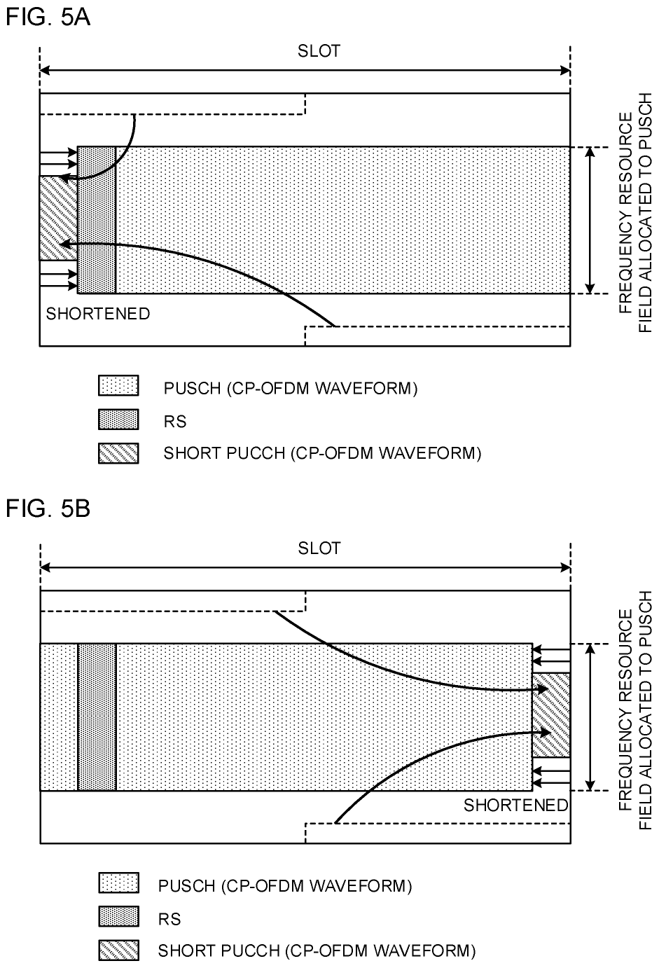

FIG. 5 are diagrams, each showing a first example of TDM according to a second example of the present invention. In FIGS. 5A and 5B, the number of PUSCH symbols in the CP-OFDM waveform is reduced (shortened PUSCH). The number and/or the starting position of PUSCH symbols in the waveform may be specified by higher layer signaling and/or DCI.

Also, in FIGS. 5A and 5B, at least a part of the frequency resources (for example, one or more REs, one or more subcarriers, one or more PRBs, and so forth) in the frequency resource field allocated to this PUSCH may be allocated to a short PUCCH that is time-division-multiplexed (TDM) with the PUSCH.

For example, in FIG. 5A, the user terminal maps a short PUCCH, to which UCI is re-directed (and which is therefore used to transmit the UCI), to a certain number of symbols (for example, 1 symbol) before a shortened PUSCH. As shown in FIG. 5A, if a short PUCCH is mapped to a symbol before a PUSCH, the user terminal can quickly transmit an HARQ-ACK in response to the PDSCH received in the previous slot, as feedback, to the radio base station.

In FIG. 5B, the user terminal maps a short PUCCH, to which UCI is re-directed, to a certain number of symbols (for example, 1 symbol) following a shortened PUSCH. As shown in FIG. 5B, when a short PUCCH is mapped to symbols after a PUSCH, the user terminal can map the short PUCCH to a certain number of symbols at the end of the slot, as in a self-contained slot. This makes possible time-division-multiplexing (TDM) and/or frequency division-multiplexing (FDM) with other user terminals' short PUCCHs, so that the spectral efficiency can be improved.

According to the first example of TDM, a PUSCH of the CP-OFDM waveform is shortened, and UCI is transmitted by using a short PUCCH that is mapped to symbols before and after this PUSCH, so that it is possible to reduce the processing load on the user terminal related to the TDM of the PUSCH and the short PUCCH, compared to the second example of TDM, which will be described later.

<Second Example of TDM>

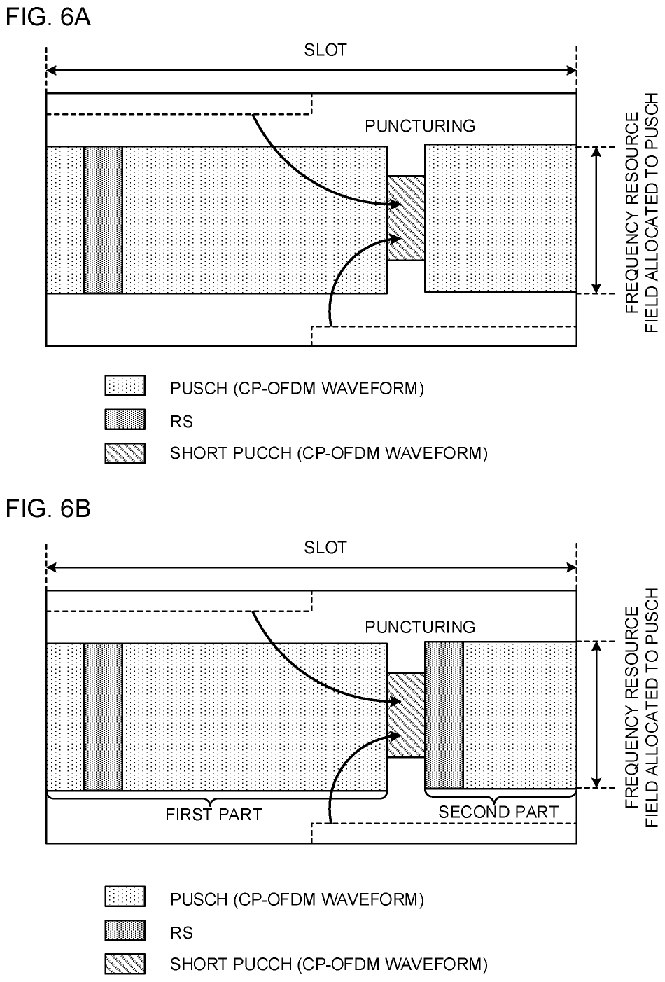

FIG. 6 are diagrams, each showing a second example of TDM according to the second example. In FIGS. 6A and 6B, part of the symbols of a PUSCH of the CP-OFDM waveform are punctured. The location of the symbols to be punctured may be specified by higher layer signaling and/or DCI.

Also, FIGS. 6A and 6B in the first and second examples of TDM, when a short PUCCH is time-division-multiplexed (TDM) with a PUSCH that is partially punctured, at least part of the frequency resources in the frequency resource field allocated to this PUSCH is allocated to this short PUCCH.

For example, referring to FIG. 6A, the user terminal punctures part of the symbols allocated to the PUSCH (for example, a certain number of symbols apart from the beginning or the end of the slot, a certain number of symbols in the middle of the slot, etc.). The user terminal maps a short PUCCH, to which UCI is re-directed, to a certain number (for example, 1 symbol) of symbols where the PUSCH is punctured. The user terminal transmits the UCI using this short PUCCH.

In FIG. 6B, the user terminal maps the RS to a certain number of symbols following the punctured symbols (for example, 1 symbol). Note that the CP-OFDM waveform is applied to the PUSCH, so that the RS and the PUSCH (UL data) may be frequency-division-multiplexed (FDM) over the symbols where the RS is allocated in FIG. 6B.

In FIG. 6B, the radio base station demodulates the PUSCH (the first part) before the punctured symbol by using the first RS. Meanwhile, the radio base station demodulates the PUSCH (the second part) after this puncturing by using an additional RS.

As shown in FIG. 6B, by mapping an additional RS after symbols are punctured, the radio base station can demodulate the PUSCH (the first part) before the punctured symbols and the PUSCH (the second part) after the punctured symbols, by using RS of separate symbols, respectively. As a result of this, the radio base station can properly demodulate the PUSCH after the punctured symbols.

According to the second example of TDM, a short PUCCH is mapped to a certain number of symbols where a PUSCH is punctured, so that it is possible to prevent simultaneous transmission of a PUSCH and a PUCCH, and, furthermore, eliminating the need for defining mapping rules for when UCI rides piggyback on a PUSCH. Therefore, there is no need to set forth more rules regarding PUSCH data mapping based on whether there is a PUSCH to transmit or not, whether there is a PUCCH to transmit or not, and so on, so that the processing load on the user terminal can be reduced.

As described above, according to the second example, when the CP-OFDM waveform is used for a PUSCH, UCI is transmitted by using a short PUCCH, is time-division-multiplexed (TDM) with the PUSCH, and to which at least part of the frequency resource field allocated to the PUSCH is allocated. Therefore, it is possible to transmit UCI while preventing a deterioration of coverage due to simultaneous transmission of a PUSCH and a long PUCCH.

Note that, according to the second example, the locations of symbols where a short PUCCH is mapped can be specified by a PDCCH that schedules a PUSCH (also referred to as a “UL grant” or “DCI,” etc.). For example, a field for specifying the transmission method for UCI is included in the UL grant, and, depending on the value of this field, the symbol for transmitting the short PUCCH and the number of the symbols may be selected. In this case, the short PUCCH can be allocated to appropriate symbols in consideration of inter-cell interference, resource allocation in the network as a whole and the like.

Note that, according to the second example, the locations of symbols where a short PUCCH is mapped can be specified by a PDCCH (also referred to as “DL assignment,” “DCI,” and so on) that corresponds to this UCI (for example HARQ-ACK), schedules a PUSCH (also referred to as a “UL grant” or “DCI,” etc.). For example, depending on the value of the field for specifying the PUCCH resource included in a DL grant, the symbol for transmitting the short PUCCH and the number of the symbols may be selected. In this case, the short PUCCH can be allocated to appropriate symbols in consideration of inter-cell interference, resource allocation in the network as a whole, and so forth.

Furthermore, the transmission power of this short PUCCH may be determined based on the transmission power control for a long PUCCH. In this case, it is possible to assign, properly, transmission power that is required for this UCI transmission.

Also, the transmission power of this short PUCCH may be determined based on the transmission power control for the PUSCH. For example, the short PUCCH may be transmitted using power obtained by applying a certain offset, configured by higher layer signaling or the like, to the transmission power of the PUSCH. In this manner, the gap in transmission power produced between the PUSCH transmission symbol and the short PUCCH symbol can be controlled, so that it is possible to prevent the disturbance of the waveform of transmission signals.

(Radio Communication System)

Now, the structure of a radio communication system according to the present embodiment will be described below. In this radio communication system, each radio communication method according to the above-described embodiments is employed. Note that the radio communication methods according to the herein-contained examples of the present invention may be applied individually, or may be combined and applied.

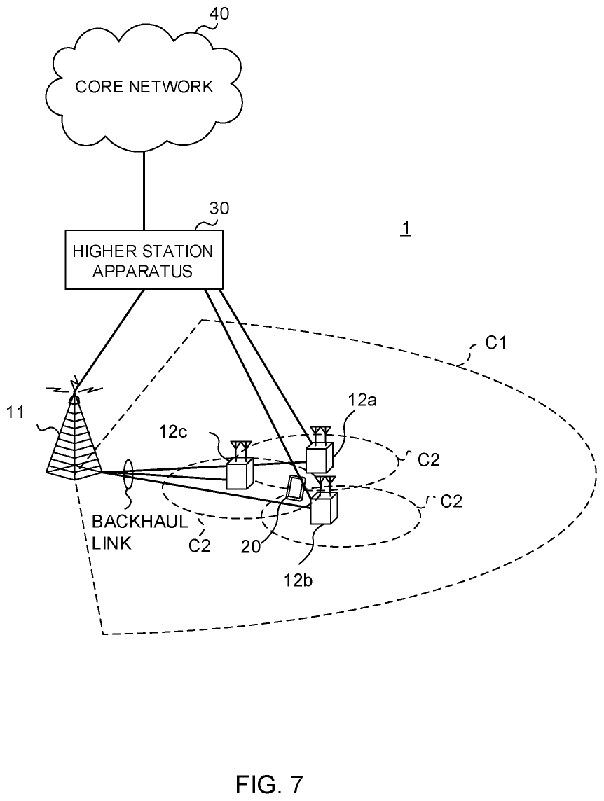

FIG. 7 is a diagram to show an example of a schematic structure of a radio communication system according to present embodiment. A radio communication system 1 can adopt carrier aggregation (CA) and/or dual connectivity (DC) to group a plurality of fundamental frequency blocks (component carriers) into one, where the LTE system bandwidth (for example, 20 MHz) constitutes 1 unit. Note that the radio communication system 1 may be referred to as “SUPER 3G,” “LTE-A (LTE-Advanced),” “IMT-Advanced,” “4G,” “5G,” “FRA (Future Radio Access),” “NR (New RAT)” and so on.

The radio communication system 1 includes a radio base station 11 that forms a macro cell C1, and radio base stations 12a to 12c that are placed within the macro cell C1 and that form small cells C2, which are narrower than the macro cell C1. Also, user terminals 20 are placed in the macro cell C1 and in each small cell C2. A structure in which different numerologies are applied between cells may be adopted. Note that a numerology refers to a set of communication parameters characterizing the design of signals in a certain RAT and/or the design of a RAT, and includes, for example, at least one of subcarrier spacing, the duration of symbols, and the duration of CPs.

The user terminals 20 can connect with both the radio base station 11 and the radio base stations 12. The user terminals 20 may use the macro cell C1 and the small cells C2, which use different frequencies, at the same time, by means of CA or DC. Also, the user terminals 20 can execute CA or DC by using a plurality of cells (CCs) (for example, 2 or more CCs). Furthermore, the user terminals can use license band CCs and unlicensed band CCs as a plurality of cells.

Furthermore, the user terminal 20 can perform communication using time division duplexing (TDD) or frequency division duplexing (FDD) in each cell. A TDD cell and an FDD cell may be referred to as a “TDD carrier (frame configuration type 2),” and an “FDD carrier (frame configuration type 1),” respectively.

Also, in each cell (carrier), either subframes having a relatively long time duration (for example, 1 ms) (also referred to as “TTIs,” “normal TTIs,” “long TTIs,” “normal subframes,” “long subframes,” “slots,” and/or the like), or subframes having a relatively short time duration (also referred to as “short TTIs,” “short subframes,” “slots” and/or the like) may be applied, or both long subframes and short subframe may be used. Furthermore, in each cell, subframes of 2 or more time lengths may be used.

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz, 30 to 70 GHz and so on) and a wide bandwidth may be used, or the same carrier as that used in the radio base station 11 may be used. Note that the structure of the frequency band for use in each radio base station is by no means limited to these.

A structure may be employed here in which wire connection (for example, optical fiber, which is in compliance with the CPRI (Common Public Radio Interface), the X2 interface and so on) or wireless connection is established between the radio base station 11 and the radio base station 12 (or between 2 radio base stations 12).

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmission/reception point” and so on. Also, the radio base stations 12 are radio base stations having local coverages, and may be referred to as “small base stations,” “micro base stations,” “pico base stations,” “femto base stations,” “HeNBs (Home eNodeBs),” “RRHs (Remote Radio Heads),” “transmission/reception points” and so on. Hereinafter the radio base stations 11 and 12 will be collectively referred to as “radio base stations 10,” unless specified otherwise.

The user terminals 20 are terminals to support various communication schemes such as LTE, LTE-A and so on, and may be either mobile communication terminals or stationary communication terminals. Furthermore, the user terminals 20 can perform inter-terminal (D2D) communication with other user terminals 20.

In the radio communication system 1, as radio access schemes, OFDMA (orthogonal Frequency Division Multiple Access) can be applied to the downlink (DL), and SC-FDMA (Single-Carrier Frequency Division Multiple Access) can be applied to the uplink (UL). OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system band into bands formed with one or continuous resource blocks per terminal, and allowing a plurality of terminals to use mutually different bands. Note that the uplink and downlink radio access schemes are not limited to the combinations of these, and OFDMA may be used in UL. Also, SC-FDMA can be applied to a side link (SL) that is used in inter-terminal communication.

In the radio communication system 1, a DL data channel (PDSCH (Physical Downlink Shared CHannel), also referred to as a DL shared channel and/or the like), which is used by each user terminal 20 on a shared basis, a broadcast channel (PBCH (Physical Broadcast CHannel)), L1/L2 control channels and so on are used as DL channels. At least one of user data, higher layer control information and SIBs (System Information Blocks) is communicated in the PDSCH. Also, the MIB (Master Information Block) is communicated in the PBCH.

The L1/L2 control channels include DL control channels (PDCCH (Physical Downlink Control CHannel), EPDCCH (Enhanced Physical Downlink Control CHannel), etc.)), a PCFICH (Physical Control Format Indicator CHannel), a PHICH (Physical Hybrid-ARQ Indicator CHannel) and so on. Downlink control information (DCI), including PDSCH and PUSCH scheduling information, is communicated by the PDCCH and/or the EPDCCH. The number of OFDM symbols to use for the PDCCH is communicated by the PCFICH. The EPDCCH is frequency-division-multiplexed with the PDSCH and used to communicate DCI and so on, like the PDCCH. PUSCH delivery acknowledgment information (A/N, HARQ-ACK, etc.) can be communicated in at least one of the PHICH, the PDCCH and the EPDCCH.

In the radio communication system 1, a UL data channel (PUSCH (Physical Uplink Shared CHannel), also referred to as a UL shared channel and/or the like), which is used by each user terminal 20 on a shared basis, an UL control channel (PUCCH (Physical Uplink Control CHannel)), a random access channel (PRACH (Physical Random Access CHannel)) and so on are used as UL channels. User data, higher layer control information and so on are communicated by the PUSCH. Uplink control information (UCI), including at least one of PDSCH delivery acknowledgement information (A/N, HARQ-ACK, etc.), channel state information (CSI) and so on, is communicated in the PUSCH or the PUCCH. By means of the PRACH, random access preambles for establishing connections with cells are communicated.

<Radio Base Station>

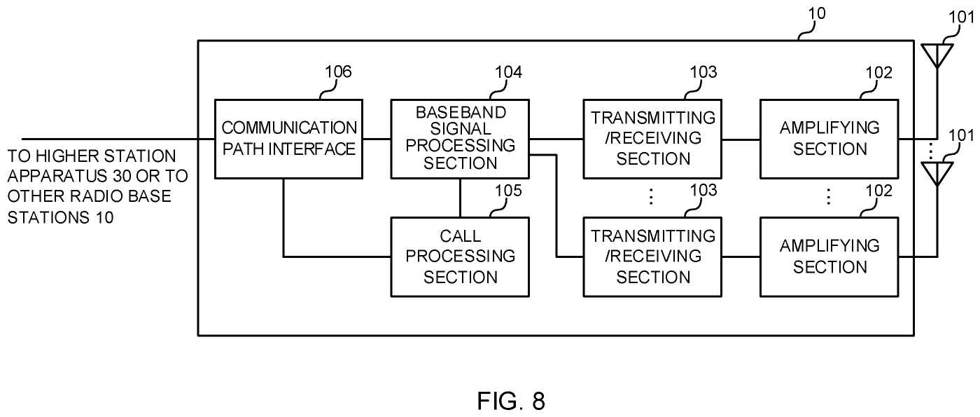

FIG. 8 is a diagram to show an example of an overall structure of a radio base station according to present embodiment. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to transmission processes, including a PDCP (Packet Data Convergence Protocol) layer process, division and coupling of the user data, RLC (Radio Link Control) layer transmission processes such as RLC retransmission control, MAC (Medium Access Control) retransmission control (for example, an HARQ (Hybrid Automatic Repeat reQuest) process), scheduling, transport format selection, channel coding, rate matching, scrambling, an inverse fast Fourier transform (IFFT) process and a precoding process, and the result is forwarded to each transmitting/receiving sections 103. Furthermore, downlink control signals are also subjected to transmission processes such as channel coding and an inverse fast Fourier transform, and forwarded to the transmitting/receiving sections 103.

Baseband signals that are pre-coded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101.

The transmitting/receiving sections 103 can be constituted by transmitters/receivers, transmitting/receiving circuits or transmitting/receiving apparatus that can be described based on general understanding of the technical field to which the present invention pertains. Note that a transmitting/receiving sections 103 may be structured as a transmitting/receiving section in one entity, or may be constituted by a transmitting section and a receiving section.

Meanwhile, as for UL signals, radio frequency signals that are received in the transmitting/receiving antennas 101 are each amplified in the amplifying sections 102. The transmitting/receiving sections 103 receive the UL signals amplified in the amplifying sections 102. The received signals are converted into the baseband signal through frequency conversion in the transmitting/receiving sections 103 and output to the baseband signal processing section 104.

In the baseband signal processing section 104, UL data that is included in the UL signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 at least performs call processing such as setting up and releasing communication channels, manages the state of the radio base station 10 or manages the radio resources.

The communication path interface section 106 transmits and receives signals to and from the higher station apparatus 30 via a certain interface. Also, the communication path interface 106 may transmit and/or receive signals (backhaul signaling) with neighboring radio base stations 10 via an inter-base station interface (for example, an interface in compliance with the CPRI (Common Public Radio Interface), such as optical fiber, the X2 interface, etc.).

In addition, the transmitting/receiving sections 103 transmit DL signals (for example, at least one of DCI (DL assignment for scheduling DL data and/or UL grant for scheduling UL data), DL data, and DL reference signals) and receive UL signals (for example, at least one of UL data, UCI, and UL reference signals).

Also, the transmitting/receiving sections 103 receive UCI from the user terminal 20, by using a UL data channel (for example, a PUSCH) or a UL control channel (for example, a short PUCCH and/or a long PUCCH). This UCI may contain at least one of an HARQ-ACK, CSI, an SR, a beam index (BI)) and a buffer status report (BSR) pertaining to a DL data channel (for example, PDSCH).

Also, the transmitting/receiving sections 103 may transmit information that indicates the waveform of the UL data channel (for example, a PUSCH) (PUSCH waveform information). The PUSCH waveform information may be either indicated explicitly by higher layer signaling and/or DCI, or may be indicated implicitly.

Also, the transmitting/receiving sections 103 may transmit information about the resources for the UL data channel and/or the UL control channel (resource information, including, for example, at least one of the number of symbols, the starting position and the frequency resource). The resource information may indicated explicitly by higher layer signaling and/or DCI, or may be indicated implicitly.

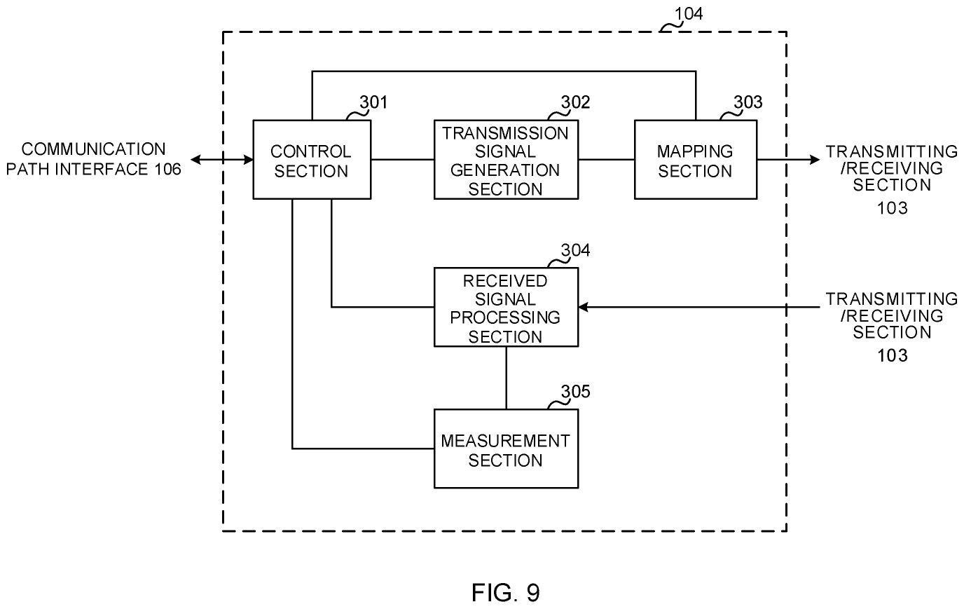

FIG. 9 is a diagram to show an exemplary functional structure of a radio base station according to present embodiment. Note that, although FIG. 9 primarily shows functional blocks that pertain to characteristic parts of the present embodiment, the radio base station 10 has other functional blocks that are necessary for radio communication as well. As shown in FIG. 9, the baseband signal processing section 104 at least has a control section 301, a transmission signal generation section 302, a mapping section 303, a received signal processing section 304 and a measurement section 305.

The control section 301 controls the whole of the radio base station 10. The control section 301 controls, for example, at least one of generation of downlink signals in the transmission signal generation section 302, mapping of downlink signals in the mapping section 303, the receiving process (for example, demodulation) of uplink signals in the received signal processing section 304, and measurements in the measurement section 305.

The control section 301 schedules user terminals 20. To be more specific, the control section 301 may control the scheduling and/or retransmission of DL data and/or UL data channels based on UCI (for example, CSI) from the user terminal 20.

In addition, the control section 301 may control the generation and/or transmission of the above PUSCH waveform information and/or the resource information.

The control section 301 may control UCI's piggyback on the PUSCH (the first example). To be more specific, the control section 301 may control the PUSCH waveform of part of the symbols to switch from the CP-OFDM waveform to the DFT-spread OFDM waveform (the second example of piggyback). For example, the control section 301 may indicate these partial symbols with the above PUSCH waveform information.

The control section 301 may control the UCI to be redirected to a short PUCCH that is time-division-multiplexed (TDM) with a PUSCH (the second example). For example, the control section 301 may indicate shortening (reduction in the number of symbols) of the PUSCH with the above resource information (the first example of TDM). In addition, the control section 301 may indicate the symbols to be punctured with the above resource information (the second example of TDM).

In addition, the control section 301 may control receiving processes for UCI from the user terminal 20. The control section 301 can be constituted by a controller, a control circuit or control apparatus that can be described based on general understanding of the technical field to which the present invention pertains.

The transmission signal generation section 302 generates DL signals (including DL data signals, DL control signals, DL reference signals and so on) based on commands from the control section 301, and outputs these signals to the mapping section 303.

The transmission signal generation section 302 can be constituted by a signal generator, a signal generation circuit or signal generation apparatus that can be described based on general understanding of the technical field to which the present invention pertains.

The mapping section 303 maps the DL signals generated in the transmission signal generation section 302 to certain radio resources based on commands from the control section 301, and outputs these to the transmitting/receiving sections 103. The mapping section 303 can be constituted by a mapper, a mapping circuit or mapping apparatus that can be described based on general understanding of the technical field to which the present invention pertains.

The received signal processing section 304 performs receiving processes (for example, demapping, demodulation, decoding, etc.) of UL signals transmitted from the user terminals 20 (including, for example, a UL data signal, a UL control signal, a UL reference signal, etc.). To be more specific, the received signal processing section 304 may output the received signals, the signals after the receiving processes and so on, to the measurement section 305. In addition, the received signal processing section 304 performs UCI receiving processes based on UL control channel configuration commanded from the control section 301.

The measurement section 305 conducts measurements with respect to the received signals. The measurement section 305 can be constituted by a measurer, a measurement circuit or measurement apparatus that can b e described based on general understanding of the technical field to which the present invention pertains.

Also, the measurement section 305 may measure the channel quality in UL based on, for example, the received power (for example, RSRP (Reference Signal Received Power)) and/or the received quality (for example, RSRQ (Reference Signal Received Quality)) of UL reference signals. The measurement results may be output to the control section 301.

(User Terminal)

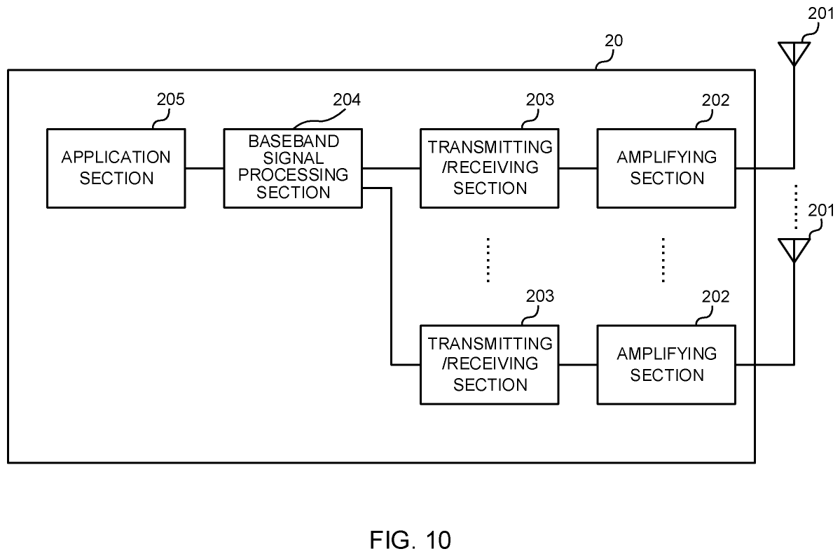

FIG. 10 is a diagram to show an example of an overall structure of a user terminal according to the present embodiment. A user terminal 20 has a plurality of transmitting/receiving antennas 201 for MIMO communication, amplifying sections 202, transmitting/receiving sections 203, a baseband signal processing section 204 and an application section 205.

Radio frequency signals that are received in a plurality of transmitting/receiving antennas 201 are each amplified in the amplifying sections 202. Each transmitting/receiving sections 203 receives the DL signals amplified in the amplifying sections 202. The received signals are subjected to frequency conversion and converted into the baseband signal in the transmitting/receiving sections 203, and output to the baseband signal processing section 204.

The baseband signal processing section 204 performs, for the baseband signal that is input, at least one of an FFT process, error correction decoding, a retransmission control receiving process and so on. The DL data is forwarded to the application section 205. The application section 205 performs processes related to higher layers above the physical layer and the MAC layer, and so on.

Meanwhile, UL data is input from the application section 205 to the baseband signal processing section 204. The baseband signal processing section 204 performs a retransmission control transmission process (for example, an HARQ transmission process), channel coding, rate matching, puncturing, a discrete Fourier transform (DFT) process, an IFFT process and so on, and the result is forwarded to each transmitting/receiving sections 203. UCI (including, for example, at least one of an A/N in response to a DL signal, channel state information (CSI) and a scheduling request (SR), and/or others) is also subjected to at least one of channel coding, rate matching, puncturing, a DFT process, an IFFT process and so on, and the result is forwarded to the transmitting/receiving sections 203.

Baseband signals that are output from the baseband signal processing section 204 are converted into a radio frequency band in the transmitting/receiving sections 203 and transmitted. The radio frequency signals that are subjected to frequency conversion in the transmitting/receiving sections 203 are amplified in the amplifying sections 202, and transmitted from the transmitting/receiving antennas 201.

In addition, the transmitting/receiving section sections 203 receive DL signals (for example, at least one of DCI (DL assignment and/or UL grant), DL data and DL reference signals) and transmit UL signals (for example, at least one of UL data, UCI, and UL reference signals).

In addition, the transmitting/receiving sections 203 transmit UCI by using a UL data channel for example, a PUSCH) or a UL control channel (for example, a short PUCCH and/or a long PUCCH).

In addition, the transmitting/receiving sections 203 may receive PUSCH waveform information, which has been mentioned earlier. Also, the transmitting/receiving sections 203 may receive the above resource information of the UL data channel and/or the UL control channel.

The transmitting/receiving sections 203 can be constituted by transmitters/receivers, transmitting/receiving circuits or transmitting/receiving apparatus that can be described based on general understanding of the technical field to which the present invention pertains. Furthermore, a transmitting/receiving section 203 may be structured as 1 transmitting/receiving section, or may be formed with a transmitting section and a receiving section.

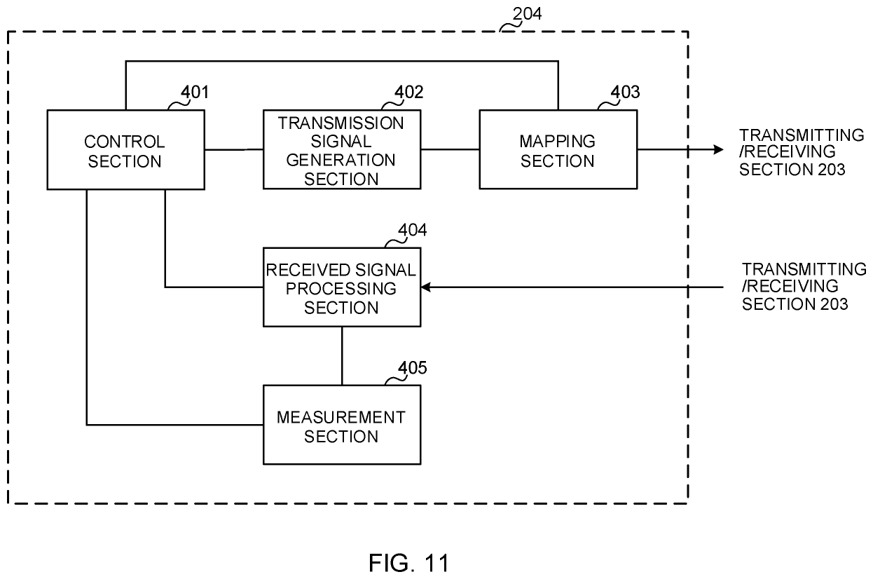

FIG. 11 is a diagram to show an exemplary functional structure of a user terminal according to present embodiment. Note that, although FIG. 11 primarily shows functional blocks that pertain to characteristic parts of the present embodiment, the user terminal 20 has other functional blocks that are necessary for radio communication as well. As shown in FIG. 11, the baseband signal processing section 204 provided in the user terminal 20 has a control section 401, a transmission signal generation section 402, a mapping section 403, a received signal processing section 404 and a measurement section 405.

The control section 401 controls the whole of the user terminal 20. The control section 401 controls, for example, at least one of generation of UL signals in the transmission signal generation section 402, mapping of UL signals in the mapping section 403, the receiving process of DL signals in the received signal processing section 404 and measurements in the measurement section 405.

In addition, the control section 401 controls the UL control channel which the user terminal 20 uses to transmit UCI, based on explicit commands from the radio base station 10 or implicit indications by the user terminal 20.

Furthermore, the control section 401 controls the transmission of UCI based on the waveform of a PUSCH (the first example). To be more specific, when the CP-OFDM waveform (multi-carrier waveform) is applied to a PUSCH, the control section 401 may control the transmission of UCI by using the PUSCH (this may be referred to as “UCI on PUSCH” or may be referred to as “piggyback on PUSCH,” and so forth) (the first example).

For example, when the PUSCH of the CP-OFDM waveform is transmitted in one or more symbols, the control section 401 may control the mapping of the UCI to frequency resources that are spread in the frequency resource field allocated to this PUSCH (see the first example of piggyback and FIG. 3).

In addition, the control section 401 applies the DFT-spread OFDM waveform (single-carrier waveform) to part of the symbols allocated to the PUSCH of the CP-OFDM waveform, and, in these symbols, the control section 401 may control the mapping of the UCI to frequency resources that are spread in the frequency resource field allocated to this PUSCH (see the second example of piggyback and FIG. 4).

When the CP-OFDM waveform (multi-carrier waveform) is applied to a PUSCH, the control section 401 may control the transmission of UCI by using a short PUCCH that is time-division-multiplexed with this PUSCH (the second example).

For example, in a certain number of symbols before and/or after the PUSCH of the CP-OFDM waveform, the control section 401 may control the mapping of a short PUCCH to at least 1 frequency resource in the frequency resource field allocated to this PUSCH (see the first example of TDM and FIG. 5)

For example, the control section 401 may puncture part of the symbols allocated to the PUSCH of the CP-OFDM waveform, and in these punctured symbols, the control section 401 may control the mapping of a short PUCCH to at least 1 frequency resource in the frequency resource field allocated to this PUSCH (see the second example of TDM and FIG. 6).

The control section 401 can be constituted by a controller, a control circuit or control apparatus that can be described based on general understanding of the technical field to which the present invention pertains.

In the transmission signal generation section 402, UL signals (including UL data signals, UL control signals, UL reference signals, UCI, etc.) are generated (including, for example, encoding, rate matching, puncturing, modulation, etc.) based on commands from the control section 401, and output to the mapping section 403. The transmission signal generation section 402 can be constituted by a signal generator, a signal generation circuit or signal generation apparatus that can be described based on general understanding of the technical field to which the present invention pertains.

The mapping section 403 maps the UL signals generated in the transmission signal generation section 402 to radio resources based on commands from the control section 401, and output the result to the transmitting/receiving sections 203. The mapping section 403 can be constituted by a mapper, a mapping circuit or mapping apparatus that can be described based on general understanding of the technical field to which the present invention pertains.

The received signal processing section 404 performs receiving processes (for example, demapping, demodulation, decoding, etc.) of DL signals (including DL data signals, scheduling information, DL control signals, DL reference signals, etc.). The received signal processing section 404 outputs the information received from the radio base station 10, to the control section 401. The received signal processing section 404 outputs, for example, broadcast information, system information, high layer control information related to higher layer signaling such as RRC signaling, physical layer control information (L1/L2 control information) and so on, to the control section 401.

The received signal processing section 404 can be constituted by a signal processor, a signal processing circuit or signal processing apparatus that can be described based on general understanding of the technical field to which the present invention pertains. Also, the received signal processing section 404 can constitute the receiving section according to the present invention.

The measurement section 405 measures channel states based on reference signals (for example, CSI-RS) from the radio base station 10, and outputs the measurement results to the control section 401. Note that the channel state measurements may be conducted per CC.

The measurement section 405 can be constituted by a signal processor, a signal processing circuit or signal processing apparatus, and a measurer, a measurement circuit or measurement apparatus that can be described based on general understanding of the technical field to which the present invention pertains.

(Hardware Structure)

Note that the block diagrams that have been used to describe the above embodiments show blocks in functional units. These functional blocks (components) may be implemented in arbitrary combinations of hardware and/or software. Also, the means for implementing each functional block is not particularly limited. That is, each functional block may be realized by one piece of apparatus that is physically and/or logically aggregated, or may be realized by directly and/or indirectly connecting 2 or more physically and/or logically separate pieces of apparatus (via wire and/or wireless, for example) and using these multiple pieces of apparatus.

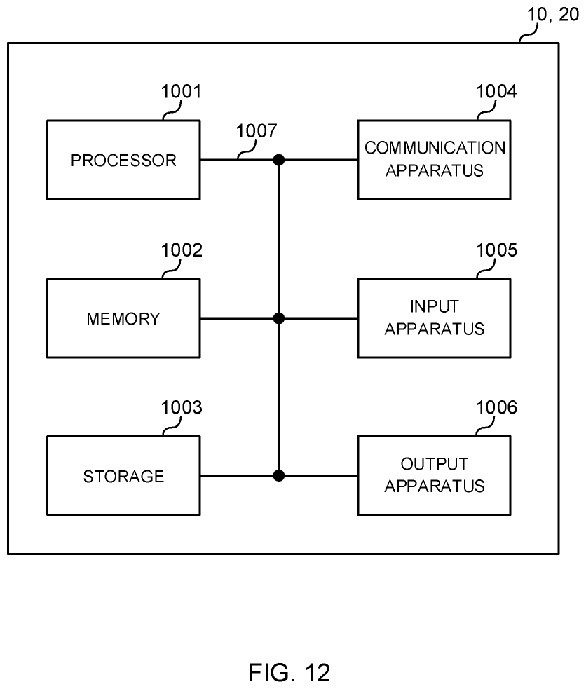

For example, the radio base station, user terminals and so on according to embodiments of the present invention may function as a computer that executes the processes of the radio communication method of the present invention. FIG. 12 is a diagram to show an example hardware structure of a radio base station and a user terminal according to present embodiment. Physically, the above-described radio base stations 10 and user terminals 20 may be formed as a computer apparatus that includes a processor 1001, a memory 1002, a storage 1003, communication apparatus 1004, input apparatus 1005, output apparatus 1006 and a bus 1007.

Note that, in the following description, the word “apparatus” may be replaced by “circuit,” “device,” “unit” and so on. Note that the hardware structure of a radio base station 10 and a user terminal 20 may be designed to include one or more of each apparatus shown in the drawings, or may be designed not to include part of the apparatus.

For example, although only 1 processor 1001 is shown, a plurality of processors may be provided. Furthermore, processes may be implemented with 1 processor, or processes may be implemented in sequence, or in different manners, on one or more processors. Note that the processor 1001 may be implemented with one or more chips.

Each function of the radio base station 10 and user terminal 20 is implemented by allowing certain software (programs) to be read on hardware such as the processor 1001 and the memory 1002, and by a least one of allowing the processor 1001 to do calculations, the communication apparatus 1004 to communicate, and the memory 1002 and the storage 1003 to read and/or write data.

The processor 1001 may control the whole computer by, for example, running an operating system. The processor 1001 may be configured with a central processing unit (CPU), which includes interfaces with peripheral apparatus, control apparatus, computing apparatus, a register and so on. For example, the above-described baseband signal processing section 104 (204), call processing section 105 and others may be implemented by the processor 1001.

Furthermore, the processor 1001 reads programs (program codes), software modules, data and so forth from the storage 1003 and/or the communication apparatus 1004, into the memory 1002, and executes various processes according to these. As for the programs, programs to allow computers to execute at least part of the operations of the above-described embodiments may be used. For example, the control section 401 of the user terminals 20 may be implemented by control programs that are stored in the memory 1002 and that operate on the processor 1001, and other functional blocks may be implemented likewise.

The memory 1002 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 1002 may be referred to as a “register,” a “cache,” a “main memory (primary storage apparatus)” and so on. The memory 1002 can store executable programs (program codes), software modules and so on for implementing the radio communication methods according to embodiments of the present invention.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving device) for allowing inter-computer communication by using wired and/or wireless networks, and may be referred to as, for example, a “network device,” a “network controller,” a “network card,” a “communication module” and so on. The communication apparatus 1004 may be configured to include a high frequency switch, a duplexer, a filter, a frequency synthesizer and so on in order to realize, for example, frequency division duplex (FDD) and/or time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, a microphone, a switch, a button, a sensor and so on). The output apparatus 1006 is an output device for allowing sending output to the outside (for example, a display, a speaker, an LED (Light Emitting Diode) lamp and so on). Note that the input apparatus 1005 and the output apparatus 1006 may be provided in an integrated structure (for example, a touch panel).

Also, each device shown in FIG. 12 is connected by a bus 1007 for communicating information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 1001 may be implemented with at least one of these pieces of hardware.

(Variations)

Note that the terminology used in this specification and the terminology that is needed to understand this specification may be replaced by other terms that convey the same or similar meanings. For example, “channels” and/or “symbols” may be replaced by “signals” (or “signaling”). Also, “signals” may be “messages.” A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency” and so on.

Furthermore, a radio frame may be comprised of one or more periods (frames) in the time domain. Each of one or more periods (frames) constituting a radio frame may be referred to as a “subframe.” Furthermore, a subframe may be comprised of one or more slots in the time domain. A subframe may be a fixed time duration (for example, 1 ms) not dependent on the numerology.

A slot may be comprised of one or more symbols in the time domain (OFDM (Orthogonal Frequency Division Multiplexing) symbols, SC-FDMA (Single Carrier Frequency Division Multiple Access) symbols, and so on). Also, a slot may be a time unit based on numerology. Also, a slot may include a plurality of minislots. Each minislot may be comprised of one or more symbols in the time domain.

A radio frame, a subframe, a slot, a minislot and a symbol all represent the time unit in signal communication. A radio frame, a subframe, a slot, a minislot and a symbol may be each called by other applicable names. For example, 1 subframe may be referred to as a “transmission time interval (TTI),” or a plurality of consecutive subframes may be referred to as a “TTI,” or 1 slot or mini-slot may be referred to as a “TTI.” That is, a subframe and/or a TTI may be a subframe (1 ms) in existing LTE, may be a shorter period than 1 ms (for example, 1 to 13 symbols), or may be a longer period of time than 1 ms.

Here, a TTI refers to the minimum time unit of scheduling in radio communication, for example. For example, in LTE systems, a radio base station schedules the radio resources (such as the frequency bandwidth and/or transmission power that can be used in each user terminal) to allocate to each user terminal in TTI units. Note that the definition of TTIs is not limited to this. The TTI may be the transmission time unit of channel-encoded data packets (transport blocks), code blocks and/or codewords, or may be the unit of processing in scheduling, link adaptation and so on. Note that, when 1 slot or 1 minislot is referred to as a “TTI,” one or more TTIs (that is, one or multiple slots or one or more minislots) may be the minimum time unit of scheduling. Also, the number of slots (the number of minislots) to constitute this minimum time unit of scheduling may be controlled.

A TTI having a time duration of 1 ms may be referred to as a “normal TTI” (TTI in LTE Rel. 8 to 12), a “long TTI,” a “normal subframe,” a “long subframe,” and so on. A TTI that is shorter than a normal TTI may be referred to as a “shortened TTI,” a “short TTI,” a “partial TTI” (or a “fractional TTI”), a “shortened subframe,” a “short subframe,” and so on.

A resource block (RB) is the unit of resource allocation in the time domain and the frequency domain, and may include one or a plurality of consecutive subcarriers in the frequency domain. Also, an RB may include one or more symbols in the time domain, and may be 1 slot, 1 minislot, 1 subframe or 1 TTI in length. 1 TTI and 1 subframe each may be comprised of one or more resource blocks. Note that an RB may be referred to as a “physical resource block (PRB (Physical RB)),” a “PRB pair,” an “RB pair,” and so on.

Furthermore, a resource block may be comprised of one or more resource elements (REs). For example, 1 RE may be a radio resource field of 1 subcarrier and 1 symbol.

Note that the structures of radio frames, subframes, slots, minislots, symbols and so on described above are merely examples. For example, configurations pertaining to the number of subframes included in a radio frame, the number of slots included in a subframe or a radio frame, the number of mini-slots included in a slot, the number of symbols included in a slot or a mini-slot, the number of subcarriers included in an RB, the number of symbols in a TTI, the duration of symbols, the duration of cyclic prefixes (CPs) and so on can be changed in a variety of ways.

Also, the information and parameters described in this specification may be represented in absolute values or in relative values with respect to certain values, or may be represented in other information formats. For example, radio resources may be specified by certain indices. In addition, equations to use these parameters and so on may be used, apart from those explicitly disclosed in this specification.

The names used for parameters and so on in this specification are in no respect limiting. For example, since various channels (PUCCH (Physical Uplink Control CHannel), PDCCH (Physical Downlink Control CHannel) and so on) and information elements can be identified by any suitable names, the various names assigned to these individual channels and information elements are in no respect limiting.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on can be output from higher layers to lower layers and/or from lower layers to higher layers. Information, signals and so on may be input and/or output via a plurality of network nodes.

The information, signals and so on that are input and/or output may be stored in a specific location (for example, a memory), or may be managed using a management table. The information, signals and so on to be input and/or output can be overwritten, updated or appended. The information, signals and so on that are output may be deleted. The information, signals and so on that are input may be transmitted to other pieces of apparatus.

Reporting of information is by no means limited to the aspects/embodiments described in this specification, and other methods may be used as well. For example, reporting of information may be implemented by using physical layer signaling (for example, downlink control information (DCI), uplink control information (UCI), higher layer signaling (for example, RRC (Radio Resource Control) signaling, broadcast information (the master information block (MIB), system information blocks (SIBs) and so on), MAC (Medium Access Control) signaling and so on), and other signals and/or combinations of these.

Note that physical layer signaling may be referred to as “L1/L2 (Layer 1/Layer 2) control information (L1/L2 control signals),” “L1 control information (L1 control signal)” and so on. Also, RRC signaling may be referred to as “RRC messages,” and can be, for example, an RRC connection setup message, RRC connection reconfiguration message, and so on. Also, MAC signaling may be reported using, for example, MAC control elements (MAC CEs (Control Elements)).

Also, reporting of certain information (for example, reporting of information to the effect that “X holds”) does not necessarily have to be sent explicitly, and can be sent implicitly (by, for example, not reporting this piece of information, or by reporting a different piece of information).

Decisions may be made in values represented by 1 bit (0 or 1), may be made in Boolean values that represent true or false, or may be made by comparing numerical values (for example, comparison against a certain value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are also included in the definition of communication media.

The terms “system” and “network” as used herein are used interchangeably.

As used herein, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or more (for example, 3) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or all of the coverage area of a base station and/or a base station subsystem that provides communication services within this coverage.

As used herein, the terms “mobile station (MS)” “user terminal,” “user equipment (UE)” and “terminal” may be used interchangeably. A base station may be referred to as a “fixed station,” “NodeB,” “eNodeB (eNB),” “access point,” “transmission point,” “receiving point,” “femto cell,” “small cell” and so on.

A mobile station may also be referred to as, for example, a “subscriber station,” a “mobile unit,” a “subscriber unit,” a “wireless unit,” a “remote unit,” a “mobile device,” a “wireless device,” a “wireless communication device,” a “remote device,” a “mobile subscriber station,” an “access terminal,” a “mobile terminal,” a “wireless terminal,” a “remote terminal,” a “handset,” a “user agent,” a “mobile client,” a “client” or some other suitable terms.

Furthermore, the radio base stations in this specification may be interpreted as user terminals. For example, each aspect/embodiment of the present invention may be applied to a configuration in which communication between a radio base station and a user terminal is replaced with communication among a plurality of user terminals (D2D (Device-to-Device)). In this case, user terminals 20 may have the functions of the radio base stations 10 described above. In addition, “uplink” and/or “downlink” may be interpreted as “sides.” For example, an uplink channel may be interpreted as a side channel.

Likewise, the user terminals in this specification may be interpreted as radio base stations. In this case, the radio base stations 10 may have the functions of the user terminals 20 described above.

Certain actions which have been described in this specification to be performed by base stations may, in some cases, be performed by higher nodes (upper nodes). In a network comprised of one or more network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

The aspects/embodiments illustrated in this specification may be used individually or in combinations, which may be switched depending on the mode of implementation. The order of processes, sequences, flowcharts and so on that have been used to describe the examples/embodiments herein may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to systems that use LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark) and other adequate radio communication methods, and/or next-generation systems that are enhanced based on these.

The phrase “based on” as used in this specification does not mean “based only on,” unless otherwise specified. In other words, the phrase “based on” means both “based only on” and “based at least on.”

Reference to elements with designations such as “first,” “second” and so on as used herein does not generally limit the number/quantity or order of these elements. These designations are used only for convenience, as a method of distinguishing between 2 or more elements. In this way, reference to the first and second elements does not imply that only 2 elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database or some other data structure), ascertaining and so on. Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

As used herein, the terms “connected” and “coupled,” or any variation of these terms, mean all direct or indirect connections or coupling between 2 or more elements, and may include the presence of one or more intermediate elements between 2 elements that are “connected” or “coupled” to each other. The coupling or connection between the elements may be physical, logical or a combination thereof. As used herein, 2 elements may be considered “connected” or “coupled” to each other by using one or more electrical wires, cables and/or printed electrical connections, and, as a number of non-limiting and non-inclusive examples, by using electromagnetic energy, such as electromagnetic energy having wavelengths in radio frequency fields, microwave regions and optical (both visible and invisible) regions.

When terms such as “include,” “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

1. A user terminal comprising:
a transmission section that transmits an uplink (UL) data channel; and
a control section that, when a multi-carrier waveform is applied to the UL data channel, controls transmission of UCI by using the UL data channel or by using a UL control channel that is time-division-multiplexed with the UL data channel.

2. The user terminal according to claim 1, wherein the control section controls mapping of the UCI to frequency resources that are spread in a frequency resource field allocated to the UL data channel, in one or more symbols in which the UL data channel is transmitted.

3. The user terminal according to claim 1, wherein the control section applies a single-carrier waveform to part of the symbols allocated to the UL data channel, and, in the part of the symbols, controls mapping of the UCI to frequency resources that are spread in a frequency resource field allocated to the UL data channel.

4. The user terminal according to claim 1, wherein the control section controls mapping of the UL control channel to at least 1 frequency resource in a frequency resource field allocated to the UL data channel, in a certain number of symbols before and/or after the UL data channel.

5. The user terminal according to claim 1, wherein the control section punctures part of symbols allocated to the UL data channel, and, in the punctured symbols, controls mapping of the UL control channel to at least 1 frequency resource in the frequency resource field allocated to the UL data channel.

6. A radio communication method comprising, in a user terminal, the steps of:
transmitting an uplink (UL) data channel; and
when a multi-carrier waveform is applied to the UL data channel, controlling transmission of UCI by using the UL data channel or by using a UL control channel that is time-division-multiplexed with the UL data channel.
